(19) United States
(12) Patent Application Publication
(10) Pub. No.: US 2017/0288718 A1
(43) Pub. Date: Oct. 5, 2017

(54) WIRELESS COMMUNICATION HELMET SYSTEM AND METHOD

(71) Applicant: HARSHA RUDRAPPA, FORT SMITH, AR (US)

(72) Inventor: HARSHA RUDRAPPA, FORT SMITH, AR (US)

(21) Appl. No.: 15/473,228

(22) Filed: Mar. 29, 2017

Related U.S. Application Data
(60) Provisional application No. 62/314,511, filed on Mar. 29, 2016.

(51) Int. Cl. H04B 1/3827; A42B 3/30; A42B 3/04

(52) U.S. Cl. CPC H04B 1/385; A42B 3/042; A42B 3/303; H04B 2001/3866; H04M 3/42042

(57) ABSTRACT

A wireless communication helmet system preferably includes a helmet assembly, a power-cord, and a control assembly. The helmet assembly preferably includes a helmet, a speaker, a microphone, and a power-supply. Preferably, the control assembly includes a wireless-communications-device, a digital-screen, and a volume-control, where the control assembly is in wireless communication with the helmet assembly, and the power-cord is removably coupleable to the helmet assembly. The wireless communication helmet system allows a user to communicate to at least one remote individual without a need to hold a communications device in a hand of the user.

### CROSS-REFERENCE TO RELATED APPLICATION(S)

The present application is related to and claims priority to U.S. Provisional Patent Application No. 62/314,511 filed Mar. 29, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of telecommunications of existing art and more specifically relates to wireless communications.

### RELATED ART

People have grown accustomed to being able to talk on a cell phone whenever they choose. This is typically not a problem in a car as a driver may still steer one-handed, or they can use a wireless communication device to talk hands-free. This is generally not an option for people who travel by bicycle or motorcycle, as they must ride with both hands on the handlebars for safety. Additionally, some people may need ride a bicycle/motorcycle without a helmet such that they may also wear a wireless earpiece at the same time, greatly increasing the risk of injury or death. A suitable solution is desired.

U.S. Publication No. 2012/0077438 to Ohjin Jung relates to a Bluetooth® headset for helmet having inter-communication function. The described Bluetooth headset for helmet having inter-communication function includes a headset body configured to be mounted on a helmet, a microphone and a speaker that are configured to be installed on the headset body, a jog dial configured to be installed to perform a rotation operation and be subject to a push operation. Also included is a Bluetooth module configured to be accommodated in the headset body and to perform wireless communication while paired with an external Bluetooth device, and a control unit configured to be accommodated in the headset body to process a signal input from the microphone, a signal input according to the rotation operation and the push operation of the jog dial and a signal received from the Bluetooth module and output the processed signal to the speaker and the Bluetooth module.

### SUMMARY OF THE INVENTION

In view of the foregoing disadvantages inherent in the known wireless communications art, the present disclosure provides a novel wireless communication helmet and method. The general purpose of the present disclosure, which will be described subsequently in greater detail, is to provide a wireless communication helmet system and method that is efficient and safe for use.

A wireless communication helmet system is disclosed herein. The wireless communication helmet system preferably includes a helmet assembly, a power-cord, and a control assembly. The helmet assembly preferably includes a helmet, a speaker, a microphone, and a power-supply. Preferably, the control assembly includes a wireless-communications-device, a digital-screen, and a volume-control, where the control assembly is in wireless communication with the helmet assembly, and the power-cord is removably coupleable to the helmet assembly. The wireless communication helmet system allows a user to communicate to at least one remote individual without a need to hold a communications device in a hand of the user.

Preferably, the control assembly includes caller-identification capabilities that are displayable upon the digital-screen and the wireless-communications-device is removably coupleable to a handlebar of a two-wheeled vehicle to provide ‘hands-free’ use of the wireless communication helmet system.

The speaker and the microphone of the helmet assembly are each preferably removable and replaceable such that the speaker and the microphone are each usable with more than one the helmet and may be replaced if one or both of them become damaged or worn. The power-supply preferably includes at least one battery integrated into the helmet assembly, where the at least one battery is rechargeable via a 120-volt electrical source via a cord-assembly.

According to another embodiment, a method of using a wireless communications helmet system is also disclosed herein. The method of using a wireless communications helmet system includes a first step, providing a wireless communications helmet system, the wireless communications system including a helmet assembly and a control assembly; a second step, affixing the control assembly to a handlebar; a third step, placing the helmet assembly upon a head of a user; a fourth step, commencing verbal communications with a remote individual; a fifth step, ceasing verbal communication with the remote individual; a sixth step, removing the control assembly from the handlebar; and a seventh step, removing the helmet assembly from the head of the user.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a wireless communication helmet system and method, constructed and operative according to the teachings of the present disclosure.

FIG. 1 is a perspective view of the wireless communication helmet system during an ‘in-use’ condition, according to an embodiment of the disclosure.

FIG. 2 is a perspective view of the wireless communication helmet system of FIG. 1, according to an embodiment of the present disclosure.

FIG. 3 is a perspective view of the control assembly of FIG. 1, according to an embodiment of the present disclosure.

FIG. 4 is a perspective view of the helmet assembly and power-cord of FIG. 1, according to an embodiment of the present disclosure.

FIG. 5 is a flow diagram illustrating a method of using a wireless communications helmet system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to wireless communications and more particularly to a wireless communication helmet system and method as used to improve the ability of a user to communicate with one or more remote individuals while using a two-wheeled vehicle, the device used in a ‘hands-free’ manner.

Generally, the present invention allows an individual to have a conversation even while they are enroute. The system includes a helmet built-in speaker and microphone for wireless communication and prevents accidents that may occur when a person attempts to bike or motorcycle one-handed and without a helmet. As disclosed, the system includes one or more straps that features volume control and caller identification. The present invention effectively eliminates the need to stop the bike or motorcycle in a safe place whenever a call is received.

The wireless communication helmet system is a helmet with built-in wireless functionality that allows a user to have a conversation while they travel on a bike or motorcycle. This system may include a full face helmet with a protective shield in the front. Some embodiments may include other helmet configurations. There may be a speaker or speakers built into the headgear next to one or both ears, and a microphone near the mouth. The helmet may pair with a cell phone via a short-range a wireless technology protocol, enabling the individual to make and receive phone calls as they ride.

There may also be a pair of handlebar-mounted devices that enable the rider to control the volume of the call and see who is calling via the caller identification. The product may vary in size and can come in a variety of color finishes depending upon user preferences and manufacturing. It may have an electrical port integrated into the exterior to allow it to be charged.

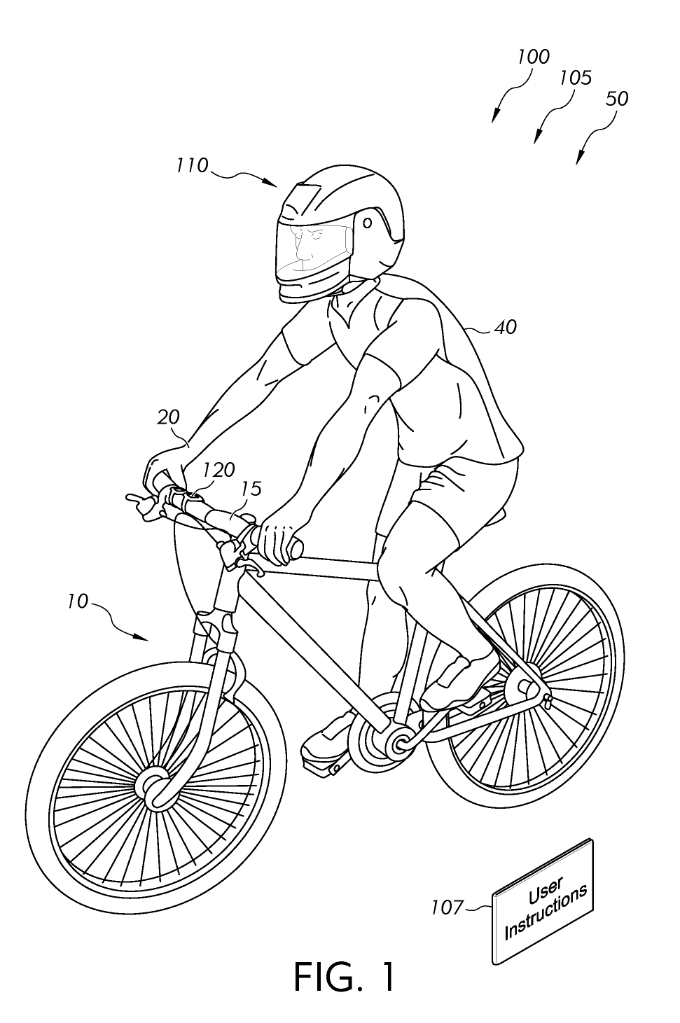

Referring now more specifically to the drawings by numerals of reference, there is shown in FIGS. 1-4, various views of a wireless communication helmet system 100. FIG. 1 shows a wireless communication helmet system 100 during an ‘in-use’ condition 50, according to an embodiment of the present disclosure. Here, the wireless communication helmet system 100 may be beneficial for use by a user 40 to make and/or receive phone calls while riding a two-wheeled vehicle 10 (e.g., bicycle, motorcycle, or the like) and speak in a ‘hands-free’ manner. As illustrated, the wireless communication helmet system 100 may include helmet assembly 110, and control assembly 120. The wireless communication helmet system 100 may be removably coupleable to handlebar 15 of a two-wheeled vehicle 10, and/or wireless-communications-device 122 may be removably coupleable to wrist 20 of user 40.

According to one embodiment, the wireless communication helmet system 100 may be arranged as a kit 105. In particular, the wireless communication helmet system 100 may further include a set of instructions 107. The instructions 107 may detail functional relationships in relation to the structure of the wireless communication helmet system 100 such that the wireless communication helmet system 100 can be used, maintained, or the like, in a preferred manner.

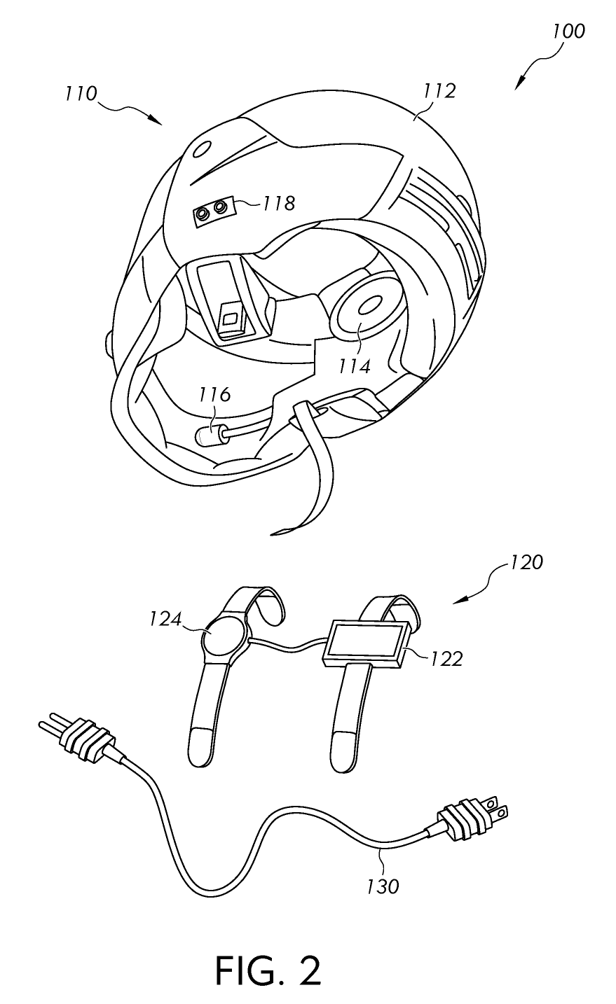

FIG. 2 shows the wireless communication helmet system 100 of FIG. 1, according to an embodiment of the present disclosure. As above, the wireless communication helmet system 100 may include helmet assembly 110. Helmet assembly 110 may include helmet 112, speaker 114, microphone 116, and power-supply 118. Control assembly 120 may include wireless-communications-device 122 and volume-control 124, control assembly 120 in wireless communication with helmet assembly 110.

Helmet 112 of helmet assembly 110 may include a bicycle-helmet, in some embodiments. Other embodiments may include helmet 112 of helmet assembly 110 which includes a motorcycle-helmet. Wireless communication helmet system 100 may allow user 40 to communicate to at least one remote individual without a need to hold a communications device in a hand of user 40.

Embodiments may include wireless communication helmet system 100 further comprising power-cord 130; with power-cord 130 removably coupleable to helmet assembly 110. Wireless-communications-device 122 may include a mobile-phone detachably coupleable to volume-control 124 in embodiments. Other embodiments may include wireless-communications-device 122 which may be a tablet-computer detachably coupleable to volume-control 124. Wireless-communications-device 122 may be integrated with/to control assembly 120 in some embodiments.

Helmet assembly 110 may further include a camera (not shown) such that a real-time video image of user 40 may be transmittable to the remote individual. Also, speaker 114 and microphone 116 may each be removable and replaceable such that speaker 114 and microphone 116 are each usable with more than one helmet 112 or may be replaced if one or both becomes damaged or worn.

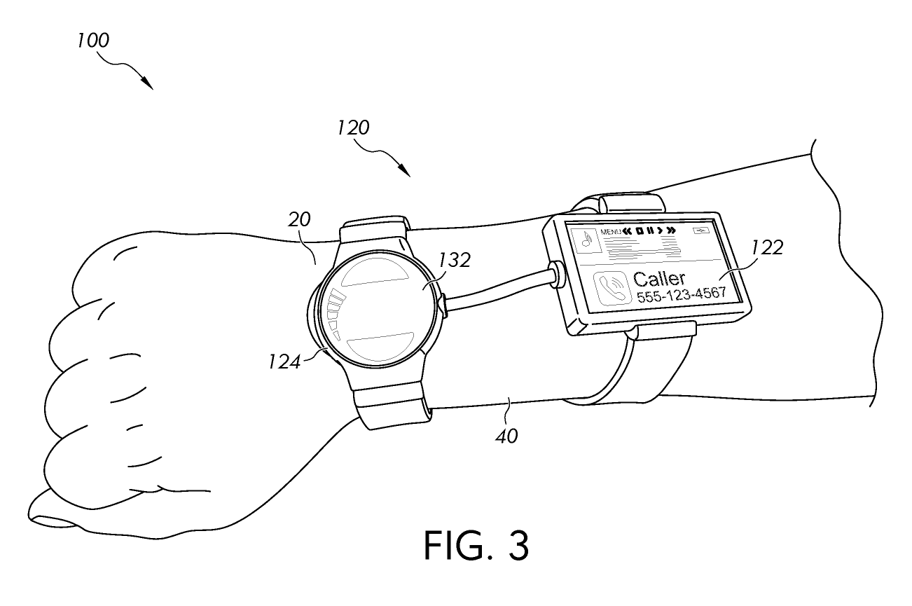

FIG. 3 is a perspective view of control assembly 120 of wireless communication helmet system 100 of FIG. 1, according to an embodiment of the present disclosure. As shown, control assembly 120 may include volume control 124 including digital-screen 132 electronically coupled to wireless-communications device 122. Control assembly 120 may include caller-identification capabilities that are displayable upon digital-screen 132. As previously stated, wireless-communications device 100 may be removably coupleable to handlebar 15 of a two-wheeled vehicle 10 in some embodiments and removably coupleable to wrist 20 of user 40 in other embodiments. Other embodiments may include wireless-communications 122 device removably coupleable to other objects, components of two-wheeled vehicle 10, or other body parts of user 40.

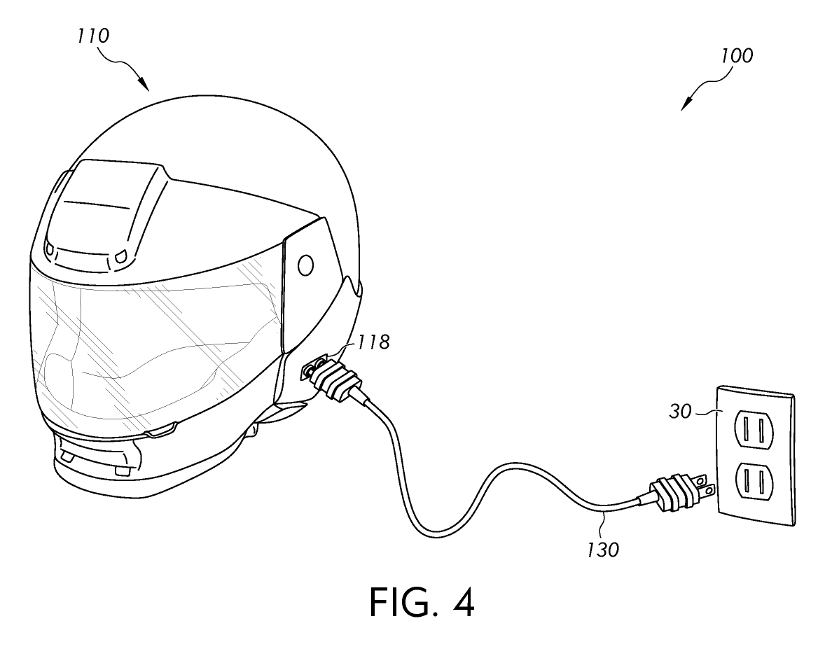

FIG. 4 is a perspective view of helmet assembly 110 and power-cord 130 of wireless communication helmet system 100 of FIG. 1, according to an embodiment of the present disclosure. Power-supply 118 may include at least one battery integrated into helmet assembly 110 in embodiments. Further embodiments may include the least one battery rechargeable via 120-volt electrical source 30 via power-cord 130. Also, power-supply 118 may include batteries which are removable from helmet assembly 110 and replaceable, with embodiments including batteries of power-supply 118 which include removable and rechargeable batteries.

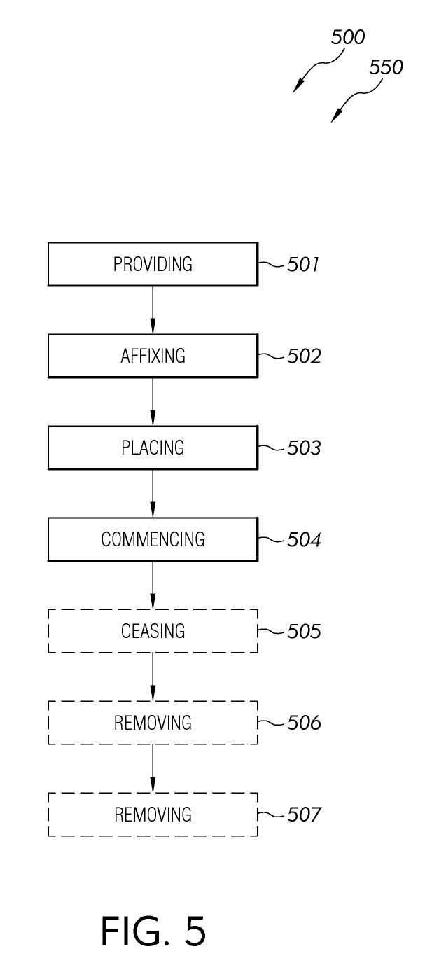

FIG. 5 is a flow diagram 550 illustrating a method for using (method of use 500) a wireless communications helmet system 100, according to an embodiment of the present disclosure. In particular, the method for method of using 500 a wireless communications helmet system 100 may include one or more components or features of the wireless communications helmet system 100 as described above. As illustrated, the method for method of using 500 a wireless communications helmet system 100 may include the steps of: step one 501, providing wireless communications helmet system 100, wireless communications system 100 including helmet assembly 110 and control assembly 120; step two 502, affixing control assembly 120 to handlebar 15; step three 503, placing helmet assembly 110 upon the head of user 40; step four 504, commencing verbal communications with a remote individual; step five 505, ceasing verbal communication with the remote individual; step six 506, removing control assembly 120 from handlebar; and step seven 507, removing helmet assembly 110 from the head of user 40.

It should be noted that step five 505, step six 506, and step seven 507 are an optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. §112(f). It should also be noted that, under appropriate circumstances, considering such issues as design preference, user preferences, marketing preferences, cost, structural requirements, available materials, technological advances, etc., other methods for using a wireless communications helmet system are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A wireless communication helmet system, the comprising:
a helmet assembly, said helmet assembly including a helmet, a speaker, a microphone, and a power-supply;
a control assembly, said control assembly including a wireless-communications-device and a volume-control, said control assembly in wireless communication with said helmet assembly; and
wherein said wireless communication helmet system allows a user to communicate to at least one remote individual without a need to hold a communications device in a hand of said user.

2. The wireless communication helmet system of claim 1, further comprising a power-cord, said power-cord removably coupleable to said helmet assembly.

3. The wireless communication helmet system of claim 1, wherein said control assembly additionally includes a digital-screen.

4. The wireless communication helmet system of claim 1, wherein said control assembly includes caller-identification capabilities that are displayable upon said digital-screen.

5. The wireless communication helmet system of claim 1, wherein said helmet assembly further includes a camera such that a real-time video image of said user is transmittable to said remote individual.

6. The wireless communication helmet system of claim 1, wherein said speaker and said microphone are each removable and replaceable such that said speaker and said microphone are each usable with more than one said helmet.

7. The wireless communication helmet system of claim 1, wherein said wireless-communications-device is removably coupleable to a handlebar of a two-wheeled vehicle.

8. The wireless communication helmet system of claim 1, wherein said wireless-communications-device is removably coupleable to a wrist of said user.

9. The wireless communication helmet system of claim 1, wherein said helmet of said helmet assembly includes a bicycle-helmet.

10. The wireless communication helmet system of claim 1, wherein said helmet of said helmet assembly includes a motorcycle-helmet.

11. The wireless communication helmet system of claim 1, wherein said wireless-communications-device includes a mobile-phone detachably coupleable to said volume-control.

12. The wireless communication helmet system of claim 1, wherein said wireless-communications-device includes a tablet-computer detachably coupleable to said volume-control.

13. The wireless communication helmet system of claim 1, wherein said power-supply includes at least one battery integrated into said helmet assembly.

14. The wireless communication helmet system of claim 13, wherein said at least one battery is rechargeable via a 120-volt electrical source via a power-cord.

15. The wireless communication helmet system of claim 1, wherein said power-supply includes batteries which are removable from said helmet assembly and replaceable.

16. The wireless communication helmet system of claim 1, wherein said power-supply includes removable rechargeable batteries.

17. A wireless communication helmet system, the wireless communication helmet comprising:
a helmet assembly, said helmet assembly including a helmet, a speaker, a microphone, and a power-supply;
a power-cord, said power-cord removably coupleable to said helmet assembly;
a control assembly, said control assembly including a wireless-communications-device, a digital-screen, and a volume-control, said control assembly in wireless communication with said helmet assembly;
wherein said wireless communication helmet system allows a user to communicate to at least one remote individual without a need to hold a communications device in a hand of said user;
wherein said control assembly includes caller-identification capabilities that are displayable upon said digital-screen;
wherein said speaker and said microphone are each removable and replaceable such that said speaker and said microphone are each usable with more than one said helmet;
wherein said wireless-communications-device is removably coupleable to a handlebar of a two-wheeled vehicle;
wherein said power-supply includes at least one battery integrated into said helmet assembly; and
wherein said at least one battery is rechargeable via a 120-volt electrical source via a power-cord.

18. The wireless communication helmet system of claim 17, further comprising set of instructions; and
wherein the device is arranged as a kit.

19. A method of using a wireless communications helmet system, the method comprising the steps of:
providing a wireless communications helmet system, said wireless communications system including a helmet assembly and a control assembly;
affixing said control assembly to a handlebar;
placing said helmet assembly upon a head of a user; and
commencing verbal communications with a remote individual.

20. The method of claim 19, further comprising the steps of ceasing verbal communication with said remote individual;
removing said control assembly from said handlebar; and
removing said helmet assembly from said head of said user.
